(19) United States
(12) Patent Application Publication
(10) Pub. No.: US 2021/0340297 A1
(43) Pub. Date: Nov. 4, 2021

(54) COMPOSITION COMPRISING A BUTADIENE ELASTOMER AND A SPECIFIC FILLER, AND TIRE COMPRISING THIS COMPOSITION

(71) Applicant: COMPAGNIE GENERALE DES ETABLISSEMENTS MICHELIN, Clermont-Ferrand (FR)

(72) Inventors: KARIM EL-OTHMANI, Clermont-Ferrand (FR); JEAN-MARC MARECHAL, Clermont-Ferrand (FR)

(21) Appl. No.: 17/253,361

(22) PCT Filed: Jun. 13, 2019
(86) PCT No.: PCT/FR2019/051428

§ 371 Date: Dec. 17, 2020

(30) Foreign Application Priority Data
Jun. 19, 2018 (FR) 1855361

(51) Int. Cl. C08F 236/06; C08F 236/08; C08L 15/00; C08L 7/00; C08K 3/04; C08K 3/36; C08K 3/06; B60C 1/00

(52) U.S. Cl. CPC C08F 236/06; C08F 236/08; C08L 15/00; C08L 7/00; C08K 3/04; B60C 2001/0033; C08K 3/06; B60C 1/00; C08L 2207/04; C08L 2205/02; C08K 2201/006; C08K 3/36

(57) ABSTRACT

A rubber composition is based on an elastomeric matrix comprising at least 50 phr of butadiene elastomer, at most 60 phr of filler comprising from 5 to 30 phr of carbon black which predominantly comprises a carbon black termed black G, and from 2 to 30 phr of inorganic filler. A finished or semi-finished rubber item and a tire are made from this composition.

### TECHNICAL FIELD OF THE INVENTION

The invention relates to a rubber composition and to a run-flat tyre.

### PRIOR ART

For several years, tyre manufacturers have sought to eliminate the need for the presence of a spare wheel on board the vehicle while at the same time guaranteeing that the vehicle will be able to continue its journey despite a significant or complete loss of pressure from one or more of the tyres. This, for example, allows a service centre to be reached without the need to stop, under circumstances that are often hazardous, in order to fit the spare wheel.

When the inflation pressure is significantly reduced in comparison with the service pressure, or is even zero (this is then referred to as “run-flat” mode), the tyre must make it possible to cover a given distance at a given speed, for example 80 km at 80 km/h. This performance, referred to as “EM” (extended mobility) performance, is required by legislation or by motor vehicle manufacturers in order to allow the producer to present the tyre as being a run-flat tyre.

When the inflation pressure is close to the service pressure (this is then referred to as “normal running” mode), it is desirable for the tyre to exhibit performance, referred to as “IRM” (inflated running mode) performance, that is as high as possible. This IRM performance includes, amongst other things, the weight, the rolling resistance or even the comfort.

One envisaged solution is the use of run-flat tyres which are provided with self-supporting sidewalls, sometimes referred to by their trade designations “ZP” for “zero pressure” or “SST” for “self-supporting tyre”, or “run-flat” for running while flat.

A run-flat tyre comprising a crown comprising a crown reinforcement, which reinforcement is formed of two crown plies of reinforcing elements and surmounted by a tread, is known from the prior art. Two sidewalls extend the crown radially inwards. The tyre also comprises two beads, each comprising a bead wire and also a carcass reinforcement anchored to each of the beads and extending from the beads through the sidewalls towards the crown. The sidewalls are reinforced by rubber sidewall reinforcers that are able to support a load at reduced pressure or even with no pressure. Each rubber sidewall reinforcer is made from a crosslinkable rubber composition and must exhibit certain properties in the cured state, in particular sufficient rigidity, in order to at least partially withstand the load at reduced pressure, or even without pressure.

It is desired for the rubber compositions employed in tyres for the manufacture of sidewall reinforcers to exhibit the best possible processability, that is to say that they can be stored, are easy to shape and keep this shape until their incorporation in the tyre in order, in particular, for the architecture of the latter to be respected. The processability of the rubber composition is linked to certain properties in the raw state, in particular its plasticity to which the flow property of the composition is linked. However, these properties are often difficult to reconcile with obtaining performance in the cured state, such as endurance or reduction in the rolling resistance of the tyres in which they are incorporated.

Document FR 3 005 471 discloses a composition comprising, as predominant elastomer, a polybutadiene exhibiting a Mooney plasticity within a range of values extending from 40 to 70 Mooney units and a specific reinforcing filler, namely a carbon black exhibiting a specific surface of between 15 and 25 m²/g and an oil absorption number of compressed sample (COAN) of between 65 and 85 ml/100 g, this composition exhibiting an excellent processability. This composition is used in the inserts of sidewalls of a run-flat tyre and improves their resistance to heating.

Document WO 2014/105811 also discloses a run-flat tyre comprising sidewall inserts in which the composition is based on functional polybutadiene and a blend of a carbon black having a specific surface area of between 15 and 25 m²/g and a COAN of between 65 and 85 ml/100 g and of a carbon black having a specific surface area of between 0 and 11 m²/g, these sidewalls exhibiting high rigidity and low hysteretic loss.

The applicant has discovered a composition which has a high processability and makes it possible to obtain sidewall inserts for a run-flat tyre, having sufficient rigidity to ensure the EM performance while at the same time further lowering the rolling resistance of the tyre comprising this reinforcer, by virtue of the combination of materials used in the rubber composition according to the invention.

### SUMMARY OF THE INVENTION

The invention, described in more detail below, relates to at least one of the embodiments listed in the following points:
1. Rubber composition based:
   on an elastomeric matrix comprising at least 50 phr of butadiene elastomer;
   on a crosslinking system;
   on at most 60 phr of filler comprising:
   from 5 to 30 phr of carbon black predominantly comprising a carbon black, termed black G, having a BET specific surface area at most equal to 40 m²/g and an oil absorption number of compressed sample (COAN) at least equal to 60 ml/100 g;
   from 2 to 30 phr of inorganic filler,
      said composition not comprising a coupling agent, or comprising less than 5% by weight thereof relative to the weight of inorganic filler.
2. Composition according to the preceding embodiment, in which the butadiene elastomer is selected from the group consisting of polybutadienes, butadiene copolymers and mixtures thereof.
3. Composition according to the preceding embodiment, in which the butadiene copolymers are selected from the group consisting of butadiene/styrene copolymers and mixtures thereof.
4. Composition according to either of embodiments 1 and 2, in which the butadiene elastomer is selected from the group consisting of polybutadienes and mixtures thereof.
5. Composition according to any one of the preceding embodiments, in which the elastomeric matrix also comprises an isoprene elastomer, preferably selected from the group consisting of synthetic polyisoprenes, natural rubber, isoprene copolymers and mixtures of these elastomers.
6. Composition according to any one of the preceding embodiments, in which the butadiene elastomer is functionalized.
7. Composition according to the preceding embodiment, in which the functionalized butadiene elastomer comprises a functional group comprising a function selected from the group consisting of alkoxysilane, silanol, amine, carboxylic acid and polyether functions, and combinations thereof, preferably consisting of alkoxysilane, silanol and amine functions, and combinations thereof.
8. Composition according to the preceding embodiment, in which the functionalized butadiene elastomer comprises a functional group comprising at least one amine function.
9. Composition according to any one of embodiments 6 to 8, in which the functionalized butadiene elastomer is coupled and/or star-shaped.
10. Composition according to any one of the preceding embodiments, comprising from 50 to 80 phr, preferentially from 50 to 70 phr, of butadiene elastomer and preferably from 20 to 50 phr, preferentially from 30 to 50 phr, of isoprene elastomer.
11. Composition according to any one of the preceding embodiments, in which the black G has a COAN number at least equal to 65 ml/100 g, preferably at least equal to 70 ml/100 g.
12. Composition according to any one of the preceding embodiments, in which the black G has a COAN number at most equal to 90 ml/100 g.
13. Composition according to any one of the preceding embodiments, in which the black G has a BET specific surface area at most equal to 30 m²/g, preferentially at most equal to 25 m²/g.
14. Composition according to any one of the preceding embodiments, in which the black G has a BET specific surface area at least equal to 15 m²/g.
15. Composition according to any one of the preceding embodiments, in which the black G content is within a range of values extending from 5 to 30 phr, preferably from 10 to 30 phr.
16. Composition according to any one of the preceding embodiments, not comprising carbon black of which the BET surface area is less than 15 m²/g or comprising less than 10 phr, preferably less than 5 phr, preferably less than 2 phr, preferentially less than 1 phr, thereof.
17. Composition according to any one of the preceding embodiments, in which the inorganic filler is selected from the group consisting of silica, alumina, chalk, clay, bentonite, talc, kaolin, glass microbeads, glass flakes, and mixtures thereof, preferably consisting of silica, chalk, clay, bentonite, talc, kaolin, and mixtures thereof.
18. Composition according to any one of the preceding embodiments, comprising from 3 to 30 phr, preferably from 3 to 20 phr and very preferably from 3 to 15 phr of inorganic filler.
19. Composition according to any one of the preceding embodiments, in which the inorganic filler comprises from 3 to 15 phr of silica.
20. Composition according to any one of the preceding embodiments, not comprising a coupling agent, or comprising less than 2% by weight, preferably less than 1% by weight, thereof relative to the weight of inorganic filler.
21. Composition according to any one of the preceding embodiments, comprising at most 50 phr of filler, preferentially at most 40 phr of filler, and preferably at most 35 phr of filler.
22. Finished or semi-finished rubber item comprising a composition according to any one of embodiments 1 to 21.
23. Tyre comprising a composition according to any one of embodiments 1 to 21.
24. Tyre according to the preceding embodiment, in which the rubber composition according to any one of embodiments 1 to 21 is present in at least one internal layer.
25. Tyre according to the preceding embodiment, in which the rubber composition according to any one of embodiments 1 to 21 is present in an internal layer selected from the group consisting of crown feet, decoupling layers, edge rubbers, padding rubbers, the tread underlayer, the sidewall reinforcer and combinations of these internal layers.
26. Flat-run tyre, characterized in that it comprises a sidewall reinforcer comprising a composition according to any one of embodiments 1 to 21.

### BRIEF DESCRIPTION OF THE DRAWINGS

The invention will be understood better from reading the following description, which is given solely by way of non-limiting example and with reference to the drawing (not shown to scale), in which:

FIG. 1 schematically depicts, in radial cross-sectional view, a tire according to one embodiment of the invention.

### DETAILED DESCRIPTION

### Definitions

The expression “part by weight per hundred parts by weight of elastomer” (or phr) should be understood as meaning, for the purposes of the present invention, the part by weight per hundred parts by weight of elastomer or of rubber, the two terms being synonyms.

In the present document, unless expressly indicated otherwise, all the percentages (%) indicated are percentages (%) by weight.

Furthermore, any interval of values denoted by the expression “between a and b” represents the range of values extending from more than “a” to less than “b” (i.e. limits a and b excluded), while any interval of values denoted by the expression “from a to b” means the range of values extending from “a” up to “b” (i.e. including the strict limits a and b).

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant polymer is the polymer representing the greatest weight with respect to the total weight of the polymers in the composition. In the same way, a “predominant” filler is that representing the greatest weight among the fillers of the composition. By way of example, in a system comprising just one polymer, the latter is predominant for the purposes of the present invention and, in a system comprising two polymers, the predominant polymer represents more than half of the weight of the polymers. Preferably, the term “predominant” is understood to mean present at more than 50%, preferably more than 60%, 70%, 80%, 90%, and more preferentially the “predominant” compound represents 100%.

For the purposes of the present invention, the term “elastomeric matrix” is intended to mean all of the elastomers (or rubbers) of the rubber composition. Thus, the elastomeric matrix can in particular consist of a single elastomer but also of a blend of two or more elastomers.

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The transversal or axial direction of the tyre is parallel to the axis of rotation of the tyre.

The radial direction is a direction which crosses the axis of rotation of the tyre and is perpendicular thereto.

The axis of rotation of the tyre is the axis about which it turns in normal use.

A radial or meridian plane is a plane which contains the axis of rotation of the tyre.

The circumferential median plane, or equatorial plane, is a plane perpendicular to the axis of rotation of the tyre and which divides the tyre into two halves.

The compounds comprising carbon mentioned in the description can be of fossil origin or biosourced. In the latter case, they can result, partially or completely, from biomass or be obtained from renewable starting materials resulting from biomass. Polymers, plasticizers, fillers, and the like, are concerned in particular.

Elastomers

The rubber composition according to the invention is based on at least 50 phr of at least one butadiene elastomer. Thus, the composition according to the invention may contain one or more butadiene elastomers or a mixture of one or more butadiene elastomers with one or more other elastomers, for example diene elastomers other than butadiene elastomers.

“Diene” elastomer (or, without distinction, rubber), whether natural or synthetic, should be understood, in a known way, as meaning an elastomer composed, at least in part (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin).

“Diene elastomer capable of being used in the compositions in accordance with the invention” is understood particularly to mean:
(a) any homopolymer of a conjugated or non-conjugated diene monomer having from 4 to 18 carbon atoms;
(b) any copolymer of a conjugated or non-conjugated diene having from 4 to 18 carbon atoms and of at least one other monomer.

The other monomer can be ethylene, an olefin or a conjugated or non-conjugated diene.

Suitable as conjugated dienes are conjugated dienes having from 4 to 12 carbon atoms, especially 1,3-dienes, such as, in particular, 1,3-butadiene and isoprene.

Suitable as non-conjugated dienes are non-conjugated dienes having from 6 to 12 carbon atoms, such as 1,4-hexadiene, ethylidenenorbomene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Suitable as aliphatic α-monoolefins are in particular acyclic aliphatic α-monoolefins having from 3 to 18 carbon atoms.

More particularly, the diene elastomer is:
(a′) any homopolymer of a conjugated diene monomer, in particular any homopolymer obtained by polymerization of a conjugated diene monomer having from 4 to 12 carbon atoms;
(b′) any copolymer obtained by copolymerization of one or more conjugated dienes with one another or with one or more vinylaromatic compounds having from 8 to 20 carbon atoms;
(c′) any copolymer obtained by copolymerization of one or more conjugated or non-conjugated dienes with ethylene, an α-monoolefin or a mixture thereof, such as, for example, the elastomers obtained from ethylene, from propylene with a non-conjugated diene monomer of the abovementioned type.

The diene elastomer is preferably an essentially unsaturated diene elastomer, in particular of type (a′) or (b′) described above.

The butadiene elastomer of the composition according to the invention is preferentially selected from the group consisting of polybutadienes (abbreviated to “BR”), butadiene copolymers and mixtures thereof. Such butadiene copolymers are more preferentially selected from the group consisting of butadiene/styrene (SBR) copolymers and mixtures thereof. Preferably, the butadiene elastomer is selected from the group consisting of polybutadienes and mixtures thereof.

The elastomeric matrix of the composition according to the invention also preferably comprises an isoprene elastomer.

“Isoprene elastomer” is understood to mean an isoprene homopolymer or copolymer, in other words a diene elastomer selected from the group consisting of natural rubber (NR), which may be plasticized or peptized, synthetic polyisoprenes (IRs), the various isoprene copolymers, in particular isoprene/styrene (SIRs), isoprene/butadiene (BIRs) or isoprene/butadiene/styrene (SBIRs) copolymers, and the mixtures of these elastomers.

Preferably, the isoprene elastomer is selected from the group consisting of synthetic polyisoprenes, natural rubber, isoprene copolymers and mixtures thereof, preferably from the group consisting of natural rubber, polyisoprenes comprising a weight ratio of cis-1,4 bonds of at least 90%, more preferentially of at least 98% relative to the weight of isoprene elastomer, and mixtures thereof. Preferably, the isoprene elastomer is natural rubber.

Preferably, the isoprene and/or butadiene elastomer is functionalized, that is to say comprises at least one functional group. “Functional group” is understood to mean a group comprising at least one heteroatom selected from Si, N, S, O and P.

Preferably, the butadiene elastomer is functionalized. The functionalized butadiene elastomer preferably comprises a functional group comprising a function selected from the group consisting of alkoxysilane, silanol, amine, carboxylic acid and polyether functions, and combinations thereof, preferably comprising a function selected from the group consisting of alkoxysilane, silanol and amine functions, and combinations thereof, and very preferably a group comprising at least one amine function.

Preferably, the functionalized butadiene elastomer is coupled and/or star-shaped, for example by means of a silicon or tin atom which bonds the elastomer chains together.

Preferably, the functionalized butadiene elastomer is selected from the group consisting of functionalized polybutadienes and mixtures thereof. In a preferred case where the functionalized butadiene elastomer is selected from the group of functionalized polybutadienes, preferably coupled and/or star-shaped, it preferentially has a content of cis-1,4 units of at most 50% and preferably of at most 40% by weight of the total weight of the polybutadiene.

Such functionalized butadiene elastomers of use for the requirements of the invention are commercially available. Mention may be made, for example, of Nipol BR 1250H™, sold by Zeon Corporation.

Preferably, the composition according to the invention comprises from 50 to 80 phr, preferentially from 50 to 70 phr, preferably from 51 to 70 phr, and very preferentially from 55 to 70 phr of butadiene elastomer, which is preferentially functionalized. Preferably, the composition according to the invention comprises from 20 to 50 phr, preferentially from 30 to 50 phr, preferably from 30 to 49 phr, and very preferentially from 30 to 45 phr of isoprene elastomer.

The isoprene elastomer confers, among other things, green tack (“tack”) on the composition. Thus, the need to use a “tackifying” resin in the rubber composition, which might increase the hysteresis of the composition and thus negatively impact the rolling resistance of the tyre according to the invention, is limited, indeed even eliminated.

Preferably, and according to any one of the arrangements according to the invention, the composition according to the invention comprises, as sole elastomers, said butadiene elastomer, which is preferentially functionalized, and said isoprene elastomer.

Fillers

The rubber composition according to the invention is based on at most 60 phr, preferentially at most 50 phr, preferably at most 40 phr, and very preferably at most 35 phr of filler comprising:
from 5 to 30 phr of carbon black predominantly comprising a carbon black, termed black G, having a BET specific surface area at most equal to 40 m²/g and an oil absorption number of compressed sample (COAN) at least equal to 60 ml/100 g;
from 2 to 30 phr of inorganic filler.

Carbon Black

All carbon blacks, notably blacks of the HAF, ISAF or SAF type, conventionally used in tyres (“tyre-grade” blacks) are suitable as carbon blacks. Among the latter, mention will be made more particularly of the reinforcing carbon blacks of the 100, 200 or 300 series (ASTM grades), for instance the N115, N134, N234, N326, N330, N339, N347 or N375 blacks, or else, depending on the applications targeted, blacks of higher series (for example N660, N683 or N772). These carbon blacks can be used in the isolated state, as available commercially, or in any other form, for example as support for some of the rubber additives used. The carbon blacks might, for example, be already incorporated in an isoprene elastomer in the form of a masterbatch (see, for example, Applications WO 97/36724 and WO 99/16600).

Carbon blacks are characterized by various properties, in particular by the specific surface area and by the oil absorption number of compressed sample (COAN for Compressed Oil Absorption Number). The COAN of carbon blacks is measured according to Standard ASTM D3493-16.

The filler of the rubber composition according to the invention comprises from 5 to 30 phr of carbon black, in the form of a single carbon black or of a blend of at least two carbon blacks. The filler of the rubber composition according to the invention predominantly comprises a carbon black, termed black G, having a BET specific surface area at most equal to 40 m²/g and an oil absorption number of compressed sample (COAN) at least equal to 60 ml/100 g.

Preferably, the black G has a COAN oil absorption number at least equal to 65 ml/100 g, preferably at least equal to 70 ml/100 g. Advantageously, the black G has a COAN at most equal to 90 ml/100 g, and preferably at most equal to 85 ml/100 g and preferably within a range of values extending from 70 ml/100 g to 80 ml/100 g.

The BET specific surface area of carbon blacks is measured according to Standard D6556-10 (multipoint (a minimum of 5 points) method—gas: nitrogen—relative pressured p/p₀ range: 0.1 to 0.3).

Preferably, the specific surface area of the black G is at most equal to 30 m²/g, preferentially at most equal to 25 m²/g. Preferably, the specific surface area of the black G is at least equal to 15 m²/g.

An example of a carbon black G of use for the requirements of the invention is N683, N660 or else “S204” sold by Orion Engineered Carbon.

The content of black G in the rubber composition according to the invention is preferentially within a range of values extending from 5 to 30 phr, preferably from 10 to 30 phr.

The carbon black predominantly, that is to say at least 50% by weight, comprises black G. Preferably, the carbon black comprises 60%, 70%, 80%, 90% by weight of black G. Very preferably, the carbon black consists of black G.

The rubber composition according to the invention preferably does not comprise carbon black, the BET surface area of which is less than 15 m²/g or comprises less than 10 phr, preferably less than 5 phr, preferably less than 2 phr, preferentially less than 1 phr, thereof.

The rubber composition according to the invention preferably does not comprise carbon black, the BET surface area of which is greater than 25 m²/g, or comprises less than 10 phr, preferably less than 5 phr, preferably less than 2 phr, preferentially less than 1 phr, thereof.

Inorganic Fillers

The rubber composition according to the invention is also based on 2 to 30 phr of inorganic filler.

The physical state in which the inorganic filler is provided is not important, whether it is in the form of a powder, micropearls, granules, beads or any other appropriate densified form.

The inorganic filler is preferably selected from mineral fillers of the siliceous type, in particular silica (SiO₂), or of the aluminous type, in particular alumina (Al₂O₃), chalk, clay, bentonite, talc, kaolin, glass microbeads, glass flakes, and a mixture thereof, preferably from silica, chalk, clay, bentonite, talc, kaolin and a mixture thereof, preferentially from silica, chalk, kaolin and a mixture thereof. Very preferably, the inorganic filler comprises silica.

The silica used can be any reinforcing silica known to those skilled in the art, in particular any precipitated or fumed silica exhibiting a BET surface area and a CTAB specific surface area both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area such as described in Application WO 03/16837.

The BET specific surface area of the silica is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressured/bio range: 0.05 to 0.17).

The CTAB specific surface area of the silica is determined according to French Standard NF T 45-007 of November 1987 (method B).

In the preferred case where the inorganic filler comprises silica, the latter preferably has a BET surface area of between 45 and 400 m²/g, more preferentially of between 60 and 300 m²/g.

The composition according to the invention does not comprise an inorganic filler-elastomer coupling agent or comprises less than 5% by weight thereof relative to the weight of inorganic filler. Preferably, the composition according to the invention does not comprise an inorganic filler-elastomer coupling agent or comprises less than 2% by weight thereof, preferably less than 1% by weight thereof relative to the weight of inorganic filler.

The term “coupling agent” (or “binding agent”) is understood to mean, in a known manner, an agent capable of coupling the inorganic filler to the elastomer.

The chalk is preferentially in the form of microparticles, the mean size (by weight) of which is greater than 1 μm. The median size of the chalk microparticles, which is a measurement obtained on a sedigraph, is preferentially between 0.5 and 200 μm, more particularly between 0.5 and 30 μm and even more preferentially between 1 and 20 μm.

The chalks known to those skilled in the art are natural calcium carbonates (chalk) or synthetic calcium carbonates with or without coating (for example with stearic acid).

By way of examples of such preferential and commercially available chalks, mention may for example be made of the chalk sold under the name “Omya BLS” by Omya.

The rubber composition according to the invention preferentially comprises from 3 to 30 phr of inorganic filler, preferably from 3 to 20 phr and very preferably from 3 to 15 phr, preferentially from 3 to 10 phr and very preferentially from 3 to 7 phr.

These filler contents associated with the elastomers of the composition according to the invention allow said filler to exhibit excellent processability, in particular low cold flow, and also a low level of hysteretic losses.

Crosslinking System

The rubber composition according to the invention comprises a crosslinking system which can be any type of system known to those skilled in the art in the field of rubber compositions for tyres. It can in particular be based on sulfur, and/or on peroxide and/or on bismaleimides.

The crosslinking system is preferentially based on sulfur. This is called a vulcanization system. The sulfur can be contributed in any form, in particular in the form of molecular sulfur, or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or also known vulcanization retarders.

The sulfur is used at a preferred content of between 1 and 10 phr, preferably between 2 and 5 phr. The vulcanization accelerator is used at a preferential content within a range extending from 1 to 7 phr, preferably extending from 2 to 5 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

Various Additives

The rubber composition according to the invention may also comprise all or some of the usual additives customarily used in elastomer compositions intended for the manufacture of tyres, such as, for example, plasticizers or extender oils, whether the latter are of aromatic or non-aromatic nature, pigments, protective agents, such as anti-ozone waxes, chemical anti-ozonants or antioxidants, anti-fatigue agents, reinforcing resins such as bismaleimides, methylene acceptors (for example, phenol-novolac resin) or methylene donors (for example, HMT or H3M).

Preferably, the rubber composition according to the invention does not comprise a reinforcing resin or comprises less than 10 phr, preferably less than 5 phr, preferably less than 2 phr, preferentially less than 1 phr and very preferably less than 0.2 phr thereof.

Reinforcing resin is understood to mean a resin known to those skilled in the art for stiffening rubber compositions. Thus, a rubber composition to which a reinforcing resin has been added will exhibit a higher stiffness, in particular a Young's modulus (measured in accordance with Standard ASTM 412-98a) or a complex dynamic shear G* (measured in accordance with Standard ASTM D 5992-96), than this composition without reinforcing resin. Such resins are, for example, phenolic resins, epoxy resins, benzoxazine resins, polyurethane resins, aminoplast resins, and the like.

Manufacture of the Compositions

The rubber composition according to the invention is manufactured in appropriate mixers using two successive preparation phases well known to those skilled in the art:
a first phase of thermomechanical working or kneading (“non-productive” phase), which can be carried out in a single thermomechanical step during which all the necessary constituents, in particular the elastomeric matrix, the fillers and the optional other various additives, with the exception of the crosslinking system, are introduced into an appropriate mixer, such as a standard internal mixer (for example of ‘Banbury’ type). The incorporation of the filler into the elastomer may be performed in one or more portions while thermomechanically kneading. In the case where the filler is already incorporated, in full or in part, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated.

The non-productive phase is carried out at high temperature, up to a maximum temperature of between 130° C. and 170° C., for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 110° C., for example between 40° C. and 100° C. The crosslinking system is then incorporated and the combined mixture is then mixed for a few minutes, for example between 1 and 30 min.

The final composition thus obtained is subsequently calendered, for example in the form of a sheet or of a plaque, in particular for a laboratory characterization, or also extruded in the form of a rubber semi-finished (or profiled) element which can be used, for example, as an internal layer in a tyre.

The composition may be either in the raw state (before crosslinking or vulcanization) or in the cured state (after crosslinking or vulcanization), may be a semi-finished product which can be used in a tyre.

The crosslinking of the composition can be carried out in a way known to those skilled in the art, for example at a temperature of between 130° C. and 200° C., preferably under pressure, for a sufficient time which can vary, for example, between 5 and 90 min.

Finished or Semi-Finished Rubber Items

A subject of the present invention is also a finished or semi-finished rubber item, and also a tyre, comprising a composition according to the invention. The invention relates to the items and tyres both in the raw state (that is to say, before curing) and in the cured state (that is to say, after crosslinking or vulcanization).

It is possible to define, within the tyre, three types of regions:
The radially exterior region in contact with the ambient air, this region essentially consisting of the tread and of the outer sidewall of the tyre. An outer sidewall is an elastomeric layer positioned outside the carcass reinforcement relative to the inner cavity of the tyre, between the crown and the bead, so as to completely or partially cover the region of the carcass reinforcement extending from the crown to the bead.
The radially interior region in contact with the inflation gas, this region generally consisting of the layer airtight to the inflation gases, sometimes known as interior airtight layer or inner liner.
The internal region of the tyre, that is to say that between the exterior and interior regions. This region includes layers or plies which are referred to here as internal layers of the tyre. These are, for example, carcass plies, tread sublayers, tyre belt plies or any other layer which is not in contact with the ambient air or the inflation gas of the tyre.

The composition defined in the present description is particularly well suited to the internal layers of the tyres.

Tyre According to the Invention

The invention also relates to a tyre comprising a rubber composition according to the invention. The present invention relates in particular to tyres intended to equip motor vehicles of passenger vehicle type, SUVs (“Sport Utility Vehicles”), or two-wheel vehicles (in particular motorcycles), or aircraft, or also industrial vehicles selected from vans, heavy-duty vehicles—that is to say, underground trains, buses, heavy road transport vehicles (lorries, tractors, trailers) or off-road vehicles, such as heavy agricultural or construction vehicles, and others, and preferably to tyres intended to equip vehicles of heavy-duty type.

Preferably, the invention relates to a tyre in which the rubber composition according to the invention is present in at least one internal layer of said tyre.

Advantageously, said internal layer of said tyre is selected from the group consisting of the crown feet, decoupling layers, edge rubbers, padding rubbers, tread underlayer, the sidewall reinforcer and combinations of these internal layers. In the present text, the term “edge rubber” is understood to mean a layer positioned in the tyre directly in contact with the end of a reinforcing ply, with the end of a reinforcing element or with another edge rubber.

The invention preferentially relates to a flat-run tyre, characterized in that it comprises a sidewall reinforcer comprising a composition according to the invention.

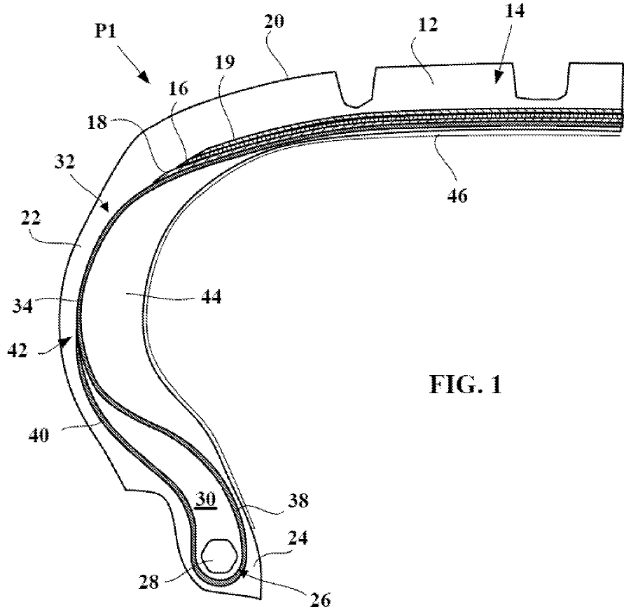

FIG. 1 schematically depicts, in radial cross-sectional view, a tyre according to one embodiment of the invention denoted by the general reference P1. The tyre P1 is of the run-flat type. The tyre P1 is intended for a passenger vehicle.

This tyre P1 comprises a crown 12 comprising a crown reinforcement 14, formed of two crown plies of reinforcing elements 16, 18 and of a hooping ply 19. The crown reinforcement 14 is surmounted by a tread 20. Here, the hooping ply 19 is positioned radially outside the plies 16, 18, between the plies 16, 18 and the tread 20. Two self-supporting sidewalls 22 extend the crown 12 radially inwards.

The tyre P1 additionally comprises two beads 24 radially on the inside of the sidewalls 22 and each comprising an annular reinforcing structure 26, in this instance a bead wire 28, from which extends radially outwards a mass of padding rubber 30 on the bead wire, and a radial carcass reinforcement 32.

The carcass reinforcement 32 extends from the beads 24 through the sidewalls 22 towards the crown 12. It comprises at least one carcass ply 34 comprising, as is well known to those skilled in the art, reinforcing elements parallel to each other extending in a plane substantially parallel to the axial direction of the tyre P1 (“radial” carcass reinforcement). In FIG. 1, the ply 34 is anchored to each of the beads 24 by a turn-up around the bead wire 28, so as to form, within each bead 24, a main strand 38 extending from the beads through the sidewalls towards the crown, and a turn-up strand 40, the radially outer end 42 of the turn-up strand 40 being substantially midway up the height of the tyre.

The rubber compositions used for the crown plies 16, 18 and carcass ply 34 are conventional compositions for the calendering of reinforcing elements, typically based on natural rubber, carbon black, a vulcanization system and the usual additives. When the reinforcing elements are textile reinforcing elements, in particular here in the carcass reinforcement, adhesion between the textile reinforcing element and the rubber composition that coats it is ensured for example by a standard adhesive of RFL type.

The tyre P1 also comprises two sidewall inserts 44, axially on the inside of the carcass reinforcement 32. These inserts 44 with their characteristic crescent-shaped radial section are intended to reinforce the sidewall. Each insert 44 is manufactured from a rubber composition based on a crosslinkable rubber composition according to the invention. Each sidewall insert 44 is capable of contributing to supporting a load corresponding to a portion of the weight of the vehicle during a run-flat situation.

The tyre also comprises an airtight inner layer 46, preferably made of butyl, located axially on the inside of the sidewalls 22 and radially on the inside of the crown reinforcement 14 and extending between the two beads 24. The sidewall inserts 44 are located axially on the outside of the inner layer 46. Thus, the sidewall inserts 44 are positioned axially between the carcass reinforcement 32 and the inner layer 46.

### EXAMPLES

Measurement Methods

The Mooney plasticity measurement is carried out according to the following principle and in accordance with Standard ASTM D-1646. The composition or the elastomer, which is generally raw, is moulded in a cylindrical chamber heated to a given temperature, usually 40° C. After preheating for one minute, a rotor of L type rotates within the test specimen at 0.02 revolutions per minute and the working torque for maintaining this movement is measured after rotating for 4 minutes. This rotational speed, lower than the usual speed of 2 rpm, makes it possible to obtain plasticity values representative of the tendency of the material to flow during its storage or after it has been shaped. The lower this value, the more the material will tend to flow.

The Mooney plasticity (ML 1+4) is expressed in “Mooney unit” (MU, with 1 MU=0.83 newton.metre). It is considered that the material can be stored, handled and shaped satisfactorily when the Mooney plasticity is between 50 and 100 MU.

The dynamic properties G* (10%) and tan(δ)max at 40° C. are measured on a viscosity analyser (Metravib VA4000) according to Standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under the defined conditions of temperature, for example at 40° C., according to Standard ASTM D 1349-99 or, as the case may be, at a different temperature, is recorded. A strain amplitude sweep is carried out from 0.1% to 50% (outward cycle) and then from 50% to 1% (return cycle). The results made use of are the complex dynamic shear modulus G* and the loss factor tan(δ). The maximum value of tan(δ) observed, denoted tan(δ)max, and the complex dynamic shear modulus G*(10%) at 10% strain, at 40° C., are shown for the return cycle. These values are expressed in base 100 taking composition T1 as reference.

Thus, for the complex dynamic shear modulus, a value lower than 100 indicates a lower modulus and therefore a less rigid composition.

It is recalled that, in a manner well known to those skilled in the art, the value of tan(δ)max at 40° C. is representative of the hysteresis of the material and therefore of the rolling resistance: the lower the tan(δ)max at 40° C., the more reduced and therefore improved the rolling resistance is. Thus, a value lower than 100 will indicate reduced rolling resistance compared to composition T1.

Preparation of the Compositions

The tests which follow are carried out in the following war the butadiene elastomer, the reinforcing filler and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one step, which lasts in total approximately from 3 to 4 min, until a maximum “dropping” temperature of 165° C. is reached.

The mixture thus obtained is recovered and cooled and then the vulcanization system is incorporated, everything being mixed (productive phase) for an appropriate time (for example between 5 and 12 min).

The compositions thus obtained are subsequently calendered, in the form of plaques (thickness of 2 to 3 mm) or of thin sheets of rubber, and are then subjected to a curing step at 150° C. for 25 min, before the measurement of their physical or mechanical properties “in the cured state”.

### Example 1

Tests were carried out with different rubber compositions presented in Table 1, based on a blend of natural rubber and an elastomer consisting of non-functional polybutadiene or a blend of natural rubber and an elastomer consisting of functional polybutadiene. Composition T1 corresponds to composition M2 of document FR 3 005 471.

The Mooney plasticity value, expressed in MU (Mooney unit), is measured for each composition in the raw state, that is to say before vulcanization.

The dynamic shear modulus and the value of tan(δ)ₘₐₓ, expressed in base 100, taking composition T1 as reference, are then measured in the cured state, therefore after vulcanization.

TABLE 1

| | T1 | T2 | I1 | I2 | I3 | I4 | I5 | I6 | I7 |
|---|---|---|---|---|---|---|---|---|---|
| NR (1) | 35 | 35 | 35 | 35 | 35 | 35 | 35 | 35 | 35 |
| Non-functional BR (2) | 65 | 65 | 65 | 65 | 65 | 65 | 0 | 0 | 0 |
| Functional BR (3) | 0 | 0 | 0 | 0 | 0 | 0 | 65 | 65 | 65 |
| Black S204 (4) | 50 | 30 | 30 | 30 | 30 | 30 | 30 | 30 | 30 |
| Silica 165G (5) | 0 | 0 | 0 | 5 | 10 | 0 | 0 | 5 | 0 |
| Chalk | 0 | 0 | 30 | 0 | 0 | 0 | 20 | 0 | 0 |
| Kaolin | 0 | 0 | 0 | 0 | 0 | 20 | 0 | 0 | 20 |
| Additives (6) | 9 | 9 | 9 | 9 | 9 | 9 | 9 | 9 | 9 |
| Total filler (phr) | 50 | 30 | 60 | 35 | 40 | 50 | 50 | 35 | 50 |
| Vulcanization system (7) | 6.2 | 6.2 | 6.2 | 6.2 | 6.2 | 6.2 | 6.2 | 6.2 | 6.2 |
| Of which insoluble Sulfur | 3.3 | 3.3 | 3.3 | 3.3 | 3.3 | 3.3 | 3.3 | 3.3 | 3.3 |
| Mooney Plasticity 1 + 4 (MU) | 71 | 38 | 60 | 70 | 88 | 70 | 91 | 72 | 91 |
| G* (10%) at 40° C. | 100 | 66 | 85 | 77 | 82 | 78 | 82 | 76 | 79 |
| tan(δ)ₘₐₓ at 40° C. | 100 | 60 | 73 | 71 | 93 | 76 | 53 | 47 | 62 |

(1) Natural rubber
(2) Non-functional polybutadiene “Buna CB24” sold by Lanxess, plasticity of 44 MU
(3) Functional polybutadiene “Nipol BR 1250H” sold by Zeon Corporation, plasticity of 50 MU
(4) Carbon black S204 from Orion Engineered Carbon, S_{BET} = 19 m²/g, COAN = 76 ml/100 g.
(5) Silica “165G” sold by Solvay
(6) The additives comprise zinc oxide (industrial grade, Umicore company), stearic acid (“Pristerene 4931” from Uniqema), N-1,3-dimethylbutyl-N-phenylparaphenylenediamine (“Santoflex 6-PPD” from Flexsys) and polymer 2,2,4-trimethyl-1,2-dihydroquinoline (TMQ)
(7) The vulcanization system comprises the insoluble sulfur, the accelerator (N,N-dicyclohexylbenzothiazole-2-sulfenamide from Flexsys) and the vulcanization retarder (N-cyclohexylthiophthalimide sold under the name “Vulkalent G” by Lanxess)

The amounts are expressed in phr (parts by weight per hundred parts of elastomers).

It is observed that the compositions according to the invention have a Mooney plasticity similar to or even greater than that of composition T1, attesting to good behaviour in terms of flow during storage or after shaping of the compositions in semi-finished form. It is noted that the compositions according to the invention have markedly reduced hysteretic losses, indicating reduced rolling resistance when these compositions are used in a tyre, while at the same time maintaining satisfactory cold properties (Mooney plasticity) and satisfactory rigidity allowing equally their storage, their shaping, and their use to constitute a sidewall insert.

### Example 2—Run-Flat Test

The tyres P1 to P5 are tyres of identical structure as shown in FIG. 1, comprising two sidewall inserts axially on the inside of the carcass reinforcement, the only difference being the composition of the sidewall inserts, as indicated in Table 2.

The run-flat test is carried out in accordance with UNECE regulation 30. A value of 0 indicates that the tested tyre failed the run-flat test. A value of 1 indicates that the tested tyre successfully passed the run-flat test.

TABLE 2

| Tyre | P1 | P2 | P3 | P4 | P5 |
|---|---|---|---|---|---|
| Composition of the sidewall inserts | T1 | I1 | I2 | I3 | I4 |
| Run-flat test | 1 | 1 | 1 | 1 | 1 |

The results of Table 2 indicate that all the tyres tested provide the required EM performance (value 1 for the run-flat test).

1.-15. (canceled)

16. A rubber composition based on:
an elastomeric matrix comprising at least 50 phr of butadiene elastomer;
a crosslinking system;
at most 60 phr of filler comprising:
from 5 to 30 phr of carbon black predominantly comprising black G carbon black having a BET specific surface area, measured according to Standard D6556-10, at most equal to 40 m²/g and an oil absorption number of compressed sample COAN, measured according to Standard ASTM D3493-16, at least equal to 60 ml/100 g; and
from 2 to 30 phr of inorganic filler,
wherein the rubber composition does not comprise a coupling agent or comprises less than 5% by weight of a coupling agent relative to a weight of inorganic filler.

17. The rubber composition according to claim 16, wherein the butadiene elastomer is selected from the group consisting of polybutadienes and mixtures thereof.

18. The rubber composition according to claim 16, wherein the elastomeric matrix further comprises an isoprene elastomer.

19. The rubber composition according to claim 16, wherein the butadiene elastomer is functionalized.

20. The rubber composition according to claim 19, wherein the functionalized butadiene elastomer comprises a functional group comprising a function selected from the group consisting of alkoxysilane, silanol, amine, carboxylic acid and polyether functions, and combinations thereof.

21. The rubber composition according to claim 20, wherein the functionalized butadiene elastomer comprises a functional group comprising at least one amine function.

22. The rubber composition according to claim 19, wherein the functionalized butadiene elastomer is coupled, is star-shaped, or is both coupled and star-shaped.

23. The rubber composition according to claim 18, wherein the butadiene elastomer is present in an amount from 50 to 80 phr and the isoprene elastomer is present in an amount from 20 to 50 phr.

24. The rubber composition according to claim 16, wherein the BET specific surface area of the black G carbon black is at most equal to 30 m²/g.

25. The rubber composition according to claim 16, wherein the rubber composition does not comprise a carbon black of which a BET surface area is less than 15 m²/g or comprises less than 10 phr of a carbon black of which a BET surface area is less than 15 m²/g.

26. The rubber composition according to claim 16, wherein the inorganic filler is selected from the group consisting of silica, alumina, chalk, clay, bentonite, talc, kaolin, glass microbeads, glass flakes, and mixtures thereof.

27. The rubber composition according to claim 16, wherein the rubber composition does not comprise the coupling agent or comprises less than 2% by weight of the coupling agent relative to the weight of inorganic filler.

28. A finished or semi-finished rubber item comprising a rubber composition according to claim 16.

29. A tire comprising a rubber composition according to claim 16.

30. A flat-run tire comprising a sidewall reinforcer comprising a rubber composition according to claim 16.
